(19) United States
(12) Patent Application Publication
(10) Pub. No.: US 2013/0043741 A1
(43) Pub. Date: Feb. 21, 2013

(54) LINEAR VIBRATION MOTOR

(71) Applicant: Jae Woo JUN, Gyunggi-do (KR)

(72) Inventor: Jae Woo JUN, Gyunggi-do (KR)

(73) Assignee: SAMSUNG ELECTRO-MECHANICS CO., LTD., Gyunggi-do (KR)

(21) Appl. No.: 13/308,448

(22) Filed: Nov. 30, 2011

(30) Foreign Application Priority Data
Aug. 19, 2011 (KR) 10-2011-0082871

(51) Int. Cl. H02K 33/00

(52) U.S. Cl. 310/15

(57) ABSTRACT

Disclosed herein is a linear vibration motor including: a stator part including a flexible printed circuit board (FPCB) having a coil fixedly coupled to an upper portion thereof; a vibrator part received in an inner portion of the stator part and including a vibration motor generating independent vibration in a linear direction and a magnet fixedly coupled to an outer peripheral surface of the vibration motor; and an elastic member having an upper end portion coupled to an upper surface of an inner side of the case and a lower end portion coupled to an upper portion of the vibrator part to thereby elastically support vibration force generated in the vibrator part.

### CROSS REFERENCE TO RELATED APPLICATION

This application claims the benefit of Korean Patent Application No. 10-2011-0082871, filed on Aug. 19, 2011, entitled “Linear Vibration Motor”, which is hereby incorporated by reference in its entirety into this application.

### BACKGROUND OF THE INVENTION

1. Technical Field

The present invention relates to a linear vibration motor.

2. Description of the Related Art

A general vibration motor, which is a component converting an electrical energy into mechanical vibration using a principle of generating electromagnetic force, is mounted in electronic devices such as a mobile communication or portable terminal, a game machine, and the like, to be used for silently notifying a user of call reception.

Currently, a linear vibration motor has been generally used as the vibration motor. The linear vibration motor is generally disposed at an edge portion of a device and generates vibration in a direction perpendicular to an object receiving the vibration.

The linear vibration motor according to the prior art includes a stator part, a vibrator part, and one elastic member coupled to the stator part and elastically supporting the vibrator part.

Therefore, since the general linear vibration motor uses one elastic member in order to elastically support the vibrator part, a user feels only a predetermined amount vibration.

On the other hand, since the linear vibration motor according to the prior art does not provide vibration force in various ranges, there is a problem in using the linear vibration motor according to the prior art in an electronic device for transferring three-dimensional tactile sensation and reaction to the user.

### SUMMARY OF THE INVENTION

The present invention has been made in an effort to provide a linear vibration motor including a vibration motor independently generating vibration force and a vibrator part independently generating another vibration force using the vibration motor as a weight body.

According to a preferred embodiment of the present invention, there is provided a linear vibration motor including: a stator part including a flexible printed circuit board (FPCB) having a coil fixedly coupled to an upper portion thereof; a vibrator part received in an inner portion of the stator part and including a vibration motor generating independent vibration in a linear direction and a magnet fixedly coupled to an outer peripheral surface of the vibration motor; and an elastic member having an upper end portion coupled to an upper surface of an inner side of the case and a lower end portion coupled to an upper portion of the vibrator part to thereby elastically support vibration force generated in the vibrator part.

The vibrator part may further include an auxiliary FPCB having one end coupled to a lower portion of the vibration motor and the other end coupled to the FPCB to thereby apply external power to the vibration motor.

The stator part may further include: a case computing an inner space in which the vibrator part is received; and a bracket coupled to a lower portion of the case, and the FPCB may be fixedly coupled to an upper portion of the bracket.

The coil may have an annular cylindrical shape in which it has an inner diameter larger than an outer diameter of the vibrator part so that the vibrator part is inserted into an inner portion thereof.

The stator part may further include a damper coupled to the upper portion of the FPCB so as to face a lower portion of the vibrator part to thereby prevent noise and impact at the time of contact between the vibrator part and the FPCB.

The vibration motor may be any one of a linear vibration motor, a flat type brush vibration motor, a flat type blushless vibration motor, and a coin type vibration motor.

### BRIEF DESCRIPTION OF THE DRAWINGS

FIG. 1 is an exploded perspective view of a linear vibration motor according to a preferred embodiment of the present invention;

FIG. 2 is a cross-sectional view showing an assembled state of the linear vibration motor shown in FIG. 1; and

FIG. 3 is a perspective view schematically showing an assembled state of an inner portion of the linear vibration motor shown in FIG. 1.

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

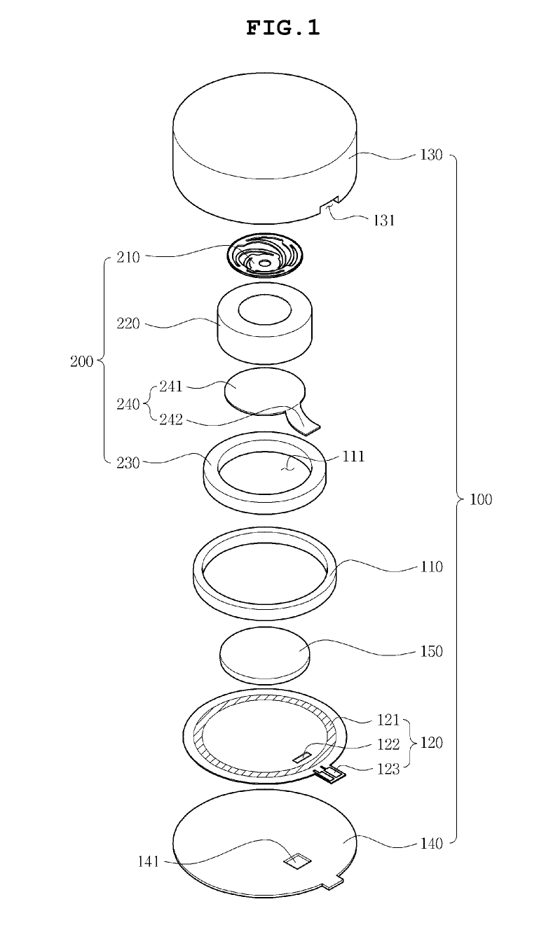

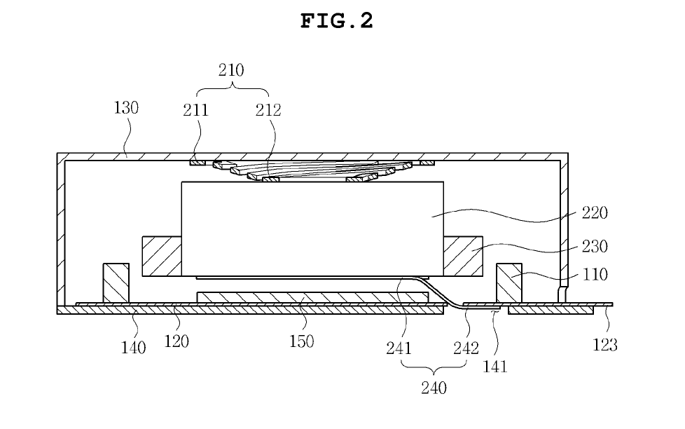

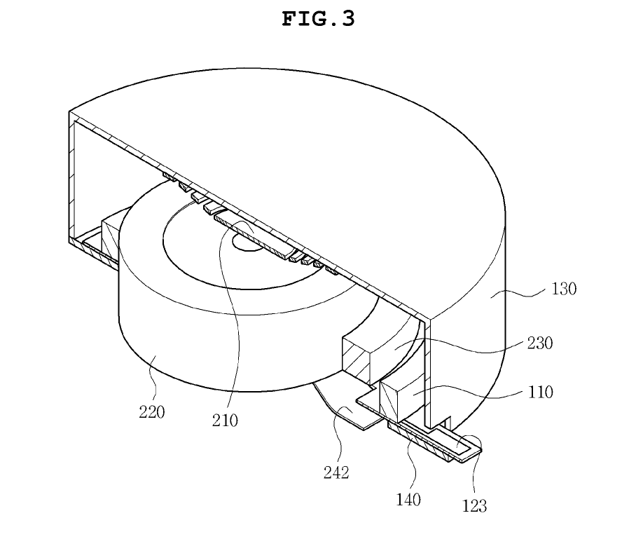

FIG. 1 is an exploded perspective view of a linear vibration motor according to a preferred embodiment of the present invention; FIG. 2 is a cross-sectional view showing an assembled state of the linear vibration motor shown in FIG. 1; and FIG. 3 is a perspective view schematically showing an assembled state of an inner portion of the linear vibration motor shown in FIG. 1. As shown, the linear vibration motor according to the preferred embodiment of the present invention includes a stator part 100, a vibrator part 200, and an elastic member 210 elastically supporting the vibrator part 200.

The stator part 100 includes a coil 110, a flexible printed circuit board (FPCB) 120, a case 130, a bracket 140, and a damper 150.

More specifically, the coil 110 is fixedly coupled to an upper portion of the FPCB 120 to thereby receive power from the outside.

In addition, the coil 110 may have an annular cylindrical shape in which it includes a hollow hole 111 formed therein so that the vibrator part 200 is inserted into an inner portion thereof to thereby move linearly, wherein the hollow hole 111 has an inner diameter larger than an outer diameter of the vibrator part 200.

The FPCB 120 is fixedly coupled to an upper portion of the bracket 140.

More specifically, the FPCB 120 may include a circuit pattern 121 formed on an upper surface thereof in order to apply external power to the coil 110, wherein the circuit pattern 131 has a cross-sectional shape corresponding to that of the coil 110.

In addition, the FPCB 120 may include a circuit pattern (not shown) formed on a lower surface thereof in order to apply the external power to an auxiliary FPCB 240 to be described below

In addition, as shown in FIG. 1, the FPCB 120 includes a through-hole 122 formed at an area outside the circuit pattern 121 so as not to be overlapped with the circuit pattern 121, wherein the through-hole 122 includes the auxiliary FPCB 240 penetrating therethrough and the auxiliary FPCB 240 configures the vibrator part 200 to be described below.

Further, the FPCB 120 includes a power connection part 123 formed at one side thereof, wherein the power connection part 123 is connected to a set component to thereby receive the external power.

The case 130 includes an inner space formed in an inner portion thereof so that the vibrator part 200 vibrates linearly, and the bracket 140 is coupled to a lower portion of the case 130 to thereby compart the inner space of the case 130.

In addition, the case 130 may include a step part 131 formed at one side thereof in order to protrude the power connection part 123 to the outside.

Further, the bracket 140 includes a through-hole 141 formed at a position corresponding to that of the through-hole 122 of the FPCB 120 so that the auxiliary FPCB 240 may be coupled to a lower surface of the power connection part 123.

In addition, the upper portion of the FPCB 120 facing a lower portion of the vibrator part 200 is mounted with the damper 150 for preventing noise and impact at the time of contact between the vibrator part 200 and the FPCB 120.

The elastic member 210 has an upper end portion 211 coupled to an upper surface of an inner side of the case 130 and a lower end portion 212 coupled to an upper portion of the vibrator part 200.

Therefore, the elastic member 210 elastically supports vibration force generated in the vibrator part 200.

According to the preferred embodiment of the present invention, the vibrator part 200 is received in inner portions of the case 130 and the bracket 140 configuring the stator part 100 to thereby generate vibration in a linear direction.

More specifically, the vibrator part 200 according to the preferred embodiment of the present invention includes a vibration motor 220 independently generating vibration, a magnet 230, and the auxiliary FPCB 240.

In addition, the linear motor 220 may be any one of a linear vibration motor, a flat type brush vibration motor, a flat type blushless vibration motor, and a coin type vibration motor according to the selection of users.

Further, the magnet 230 is fixedly coupled to an outer peripheral surface of the vibration motor 220. More specifically, the magnet 230 may have an outer diameter smaller than an inner diameter of the hollow hole 111 of the coil 110 so that it may be received in the hollow hole of the coil 110 having a cylindrical shape to thereby move linearly.

In addition, the auxiliary FPCB 240 includes a seat part 241 fixedly coupled to a lower portion of the vibration motor 220 and a connection part 242 fixedly coupled to the FPCB 120.

More specifically, the connection part 242 is coupled to the circuit pattern (not shown) formed on the lower surface of the FPCB 120 while penetrating through each of the through-hole 122 formed in the FPCB 120 and the through-hole 141 formed in the bracket 140 to thereby receive the power from the outside.

A method for operating the linear vibration motor according to the preferred embodiment of the present invention is as follows. External power is applied to the power connection part 123 protruded outwardly from one side of the FPCB 120.

Therefore, magnetic action is generated between the coil 110 and the magnet 230 coupled to the outer peripheral surface of the vibration motor 220 and the vibration motor 220 according to the preferred embodiment of the present invention serves as a weight body having a predetermined weight, such that the vibrator part 200 vibrates linearly.

That is, even though the external power is applied only to the coil 110 without being applied to the vibration motor 220, primary vibration force is generated in the linear vibration motor according to the preferred embodiment of the present invention.

At the same time, the external power is applied to the auxiliary FPCB 240 having one end coupled to the lower portion of the vibration motor 220 and the other end fixedly coupled to the lower surface of the FPCB 120.

Therefore, the vibration motor 220 itself receiving the external power generates vibration force, such that secondary vibration force is generated in the linear vibration motor.

In a sequence of the method for operating the linear vibration motor according to the preferred embodiment of the present invention described above, a generation sequence of the vibration forces may be changed anytime since the primary vibration force is generated in the vibration motor 220 and the secondary vibration force is then generated in the vibrator part 200 including the vibration motor 220.

In addition, the external power applied to the vibration motor 220 and the coil 110 may have different magnitudes.

More specifically, the circuit pattern 121 formed on the upper surface of the FPCB 120 independently applies the external power only to the coil 110 and the circuit pattern (not shown) formed on the lower surface of the FPCB 120 independently applies the external power only to the auxiliary FPCB 240, thereby making it possible to independently adjust each of the magnitudes of the external power applied to the coil 110 and the auxiliary FPCB 240 according to the selection of the user.

Therefore, since the vibration force generated in the vibration motor 220 and the vibration force generated in the vibrator part 200 may be different, the linear vibration motor according to the preferred embodiment of the present invention provides three-dimensional vibration force.

In addition, as described above, the external power may not only be applied to both of the coil 110 and the auxiliary FPCB 240 but also be selectively applied only to any one of the coil 110 and the auxiliary FPCB 240.

Therefore, the linear vibration motor according to the preferred embodiment of the present invention may not only provide the three-dimensional vibration force but also provide single vibration force similar to that of the linear vibration motor according to the prior art, according to the selection of the user.

Further, since the vibration forces are independently generated in each of the vibration motor 220 and the vibrator part 200, even though a malfunction occurs in any one of the vibration motor 220 and the vibrator part 200, the linear vibration motor may provide a predetermined vibration force to the user.

The linear vibration motor according to the preferred embodiment of the present invention includes the vibration motor independently generating vibration force and a vibrator part generating another vibration force using the vibration motor as a weight body, thereby making it possible to provide various vibration forces as compared to the linear vibration motor according to the prior art.

In addition, since the linear vibration motor according to the preferred embodiment of the present invention may provide various vibration forces, users may feel three-dimensional vibration tactile sensation.

Further, even though a malfunction occurs in any one of the vibration motor and the vibrator part that independently generate the vibration force, a predetermined amount of vibration force is provided to the user, thereby making it possible to improve reliability of a product.

Although the preferred embodiments of the present invention have been disclosed for illustrative purposes, they are for specifically explaining the present invention and thus a linear vibration motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A linear vibration motor comprising:
a stator part including a flexible printed circuit board having a coil fixedly coupled to an upper portion thereof;
a vibrator part received in an inner portion of the stator part and including a vibration motor generating independent vibration in a linear direction and a magnet fixedly coupled to an outer peripheral surface of the vibration motor; and
an elastic member having an upper end portion coupled to an upper surface of an inner side of the case and a lower end portion coupled to an upper portion of the vibrator part to thereby elastically support vibration force generated in the vibrator part.

2. The linear vibration motor as set forth in claim 1, wherein the vibrator part further includes an auxiliary FPCB having one end coupled to a lower portion of the vibration motor and the other end coupled to the FPCB to thereby apply external power to the vibration motor.

3. The linear vibration motor as set forth in claim 1, wherein the stator part further includes:
a case computing an inner space in which the vibrator part is received; and
a bracket coupled to a lower portion of the case, and
wherein the FPCB is fixedly coupled to an upper portion of the bracket.

4. The linear vibration motor as set forth in claim 1, wherein the coil has an annular cylindrical shape in which it has an inner diameter larger than an outer diameter of the vibrator part so that the vibrator part is inserted into an inner portion thereof.

5. The linear vibration motor as set forth in claim 1, wherein the stator part further includes a damper coupled to the upper portion of the FPCB so as to face a lower portion of the vibrator part to thereby prevent noise and impact at the time of contact between the vibrator part and the FPCB.

6. The linear vibration motor as set forth in claim 2, wherein the vibration motor is any one of a linear vibration motor, a flat type brush vibration motor, a flat type blushless vibration motor, and a coin type vibration motor.
